(19) United States
(12) Patent Application Publication
(10) Pub. No.: US 2016/0117743 A1
(43) Pub. Date: Apr. 28, 2016

(54) Method and system for virtual vehicle marketplace

(71) Applicant: Dealerpinch, Inc., Sherman Oaks, CA (US)

(72) Inventor: Raj Ashwin Joshi, Los Angeles, CA (US)

(21) Appl. No.: 14/920,576

(22) Filed: Oct. 22, 2015

Related U.S. Application Data
(60) Provisional application No. 62/067,283, filed on Oct. 22, 2014.

(51) Int. Cl. G06Q 30/06; G06Q 40/02

(52) U.S. Cl. CPC G06Q 30/0611; G06Q 30/0621; G06Q 30/0625; G06Q 30/0641; G06Q 40/025

(57) ABSTRACT

A computer implemented web based method for an online virtual marketplace in which the consumer can obtain information about available vehicles and preexisting leasing information and make an offer to purchase or lease vehicles. The method provides a web based database populated with vehicle information data and preexisting leasing information. A customer can lease or purchase a vehicle by searching in the electronic database for a vehicle; selecting and building the vehicle; retrieving a predetermined plurality of preexisting information for review; creating an offer for the selected and built vehicle; submitting an offer to a predetermined plurality of dealers so as to permit the dealers to evaluate the offer; and receiving the first acceptance by one of the dealers of the submitted leasing or purchase offer. A system and computer readable memory storage medium containing computer executable instructions for implementing the method are also disclosed.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/067,283, entitled “METHOD AND SYSTEM FOR VIRTUAL VEHICLE MARKETPLACE”, filed Oct. 22, 2014, the contents of which is incorporated herein by reference.

### FIELD OF THE INVENTION

The invention relates to an online virtual marketplace in which the consumer can obtain information and make an offer to purchase or lease a product. Furthermore, the invention is directed to an online virtual vehicle marketplace which allows a consumer to search for and select and build a vehicle for either purchase or a lease.

### BACKGROUND OF THE INVENTION

The buying or leasing of a vehicle can be a time consuming process. It can also be difficult and tedious for a consumer who is trying to get the best deal possible and the best car for the consumer's needs.

The problems and issues faced by a consumer, for example, in leasing a car are presented in “What I Learned the Hard Way About Leasing a Car” which appeared in the New York Times at http://bucks.blogs.nytimes.com/2013/01/08/what-i-learned-thehard-way-about-leasing-a-car/?php=true&_type=blogs&_r=0. This article noted that while “buying a car, a bastion of obfuscation, disinformation and dealer sleight-of-hand, has succumbed to the radical transparency of the Web,” but “leasing a car? That, as I so rudely discovered, is a whole other story.” This NY Times article also made clear that “Leasing is a popular way to finance a new car because of the promise of lower monthly payments than on a car loan for an outright purchase. But few sites or apps can prepare you for the emotional turmoil and financial uncertainty of negotiating a lease with a dealer.”

Dealerships are negotiating against the consumer, trying to get the most they can out of the consumer without losing the deal. Consumers dealing with sales people at car dealerships are at the disadvantage of the years of experience in sales psychology that dealership employees utilize to their advantage. Tricks used by dealerships to manipulate consumers include requirement to physically get the consumer into the dealership, knowing that a consumer who has already made that step is many times more likely to purchase while at the dealership. Dealerships have vastly greater experience with the forms and charges that they use, so they are able to present them straight-faced like a seasoned poker player as they nonchalantly include hidden fees and costs into the deal. They are also able to employ the time-honored extended hand gesture to convince a person debating the deal into actually signing.

But more than anything, dealerships are able to read cues about a consumer when they are physically present at the dealership, or by asking “required” questions if dealing with a consumer on the phone. It is an unfortunate reality of the dealership experience that certain characteristics about a consumer are part of any dealership negotiation. Dealerships customize their strategy based on assumptions derived from a consumer's name, gender, race/ethnicity, and first language allowing certain stereotypes to guide their initial offers and their negotiation tactics. Additionally, information about a consumer's address and job description allow a dealership to ascertain an approximate estimate of socioeconomic status, which then becomes a factor of the negotiation process.

To help the consumer, online sites have been created to allow the consumer to spend time shopping for a lease or purchase in a more leisurely atmosphere while at home or from a location where the consumer has access to a computer that is connected to the internet. Such an approach should help the consumer avoid the unfavorable environment sometimes present at a dealership showroom.

One online car leasing site is described in U.S. Pat. No. 8,392,280 to Kilshaw, which is incorporated herein in its entirety. It involves a computation of a lease evaluation metric that reflects the manufacturer's suggested retail price (MSRP) that is divided by an evaluation of the lease cost per mile. However, it is not certain that such a metric is a useful tool for all consumers wanting to lease a car.

The Kilshaw patent refers to a website named “ShrewdLease” which can be found at http://www.shrewdlease.com/shrewdways.php. That site includes a selection button “Using Shrewd” that instructs the user to analyze many lease offers. As mentioned in the patent, the user must enter mandatory data which consists of the MSRP and possibly other optional data. Because of the possibility of entry error, such a procedure might tend to complicate or distort the process. It is also not certain that the website fully practices the claimed invention of the Kilshaw patent. In this regard, the website suggests that the user show his results to the dealer and to ask the dealer to improve the dealer's lease offer.

Online car buying is described in US Patent Publication 2013/0226683 to Bement et al, which is incorporated herein in its entirety. Here the method concerns displaying to a potential vehicle buyer an inventory of vehicles available for purchase. Based on redemption award data input provided by the buyer, an award amount is determined as well as an available discount. The amount of the discount is also based upon information regarding an affiliation with at least one of the manufacturers and also a business affiliate of the manufacturer.

U.S. Pat. No. 8,515,821 to Center et al, which is incorporated herein in its entirety, describes an online method of referring a prospective customer to one or more automobile dealers. The system of this patent identifies those dealers that are closest to the customer. In particular, it gives preference to those with which the customer had a previous relationship. The database stores customer's contact information and information related to dealer is stored in a database. After the prospective customer is prompted to enter some personal information via a computer, a database query checks for matching data in the customer contact database and also searches the dealer locations nearest to the customer. The results are combined and the display recommends at least one dealer location. Preference is given to those dealers with where there has been a prior relationship.

Although AutoAdvisor.com sounds like an online service, it appears that the website directs the visitor to the site to call and speak with a specialist. The website suggests that the visitor work with a person and not with “a Computer Screen.” After calling, the visitor is “connected to a specialist whose job it is to learn about you and your needs.” The “specialist will listen carefully to your ideal automobile desires . . . will also listen to and address other issues important to you such as safety, trade-in, insurance, financing, leasing or even relative value of technology.” So even though it sounds like an automated operation, it actually involves a third-party person shopping and negotiating on behalf of the visitor to the site.

Another website for buying vehicles is Edmunds.com. In describing how it works, Edmunds.com specifies a three step process. The first step is “Compare upfront prices.” The second step is “Lock in your savings.” The third step is “Take your certificate to the dealer.” The website also provides a dialog box which says the buyer can get free price quotes and can “Make nearby dealers compete for your business.”

Yet another example of an online site is http://www.leasetrader.com/help. This site includes the following steps for the leasor. These include registration during which the buyer provides basic personal and contact information. This will later be used for sellers to contact the leasor, for credit approval and ultimately for the lease transfer. Another step is the buyer program during which the leasor will gain access to start contacting sellers via the message center. After being credit qualified, the leasor will have access to direct communication by phone with sellers. Next the leasor can find a vehicle by searching through the advertised leased vehicles that are available on LeaseTrader.com by means of the “Search Listings” on the website menu bar. The search includes factors that are most important to the leasor like “Year, Make, Model, Payment, Location, and Months Remaining.” The leasor can then “click” on each specific vehicle for more detailed information. Then there is the Contact Seller step. Once the leasor finds a vehicle(s) of interest, he can click on the “CONTACT SELLER” button on the “Vehicle Detail” page. After having communicated and/or negotiated the term of transfer with the seller, the leasor can start the Transfer Process clicking on the “Start Transfer Process” button located in the “Buyer Central” next to the specific vehicle picked. Or the leasor can simply pick up the telephone and contact LeaseTrader. In this manner, the leasor can speak with a lease transfer specialist who can assist in initiating, processing and finalizing the process.

Yet another website is Priceline.com's car buying service which enables buyers to name the exact car or truck they want as well as the price they want to pay. See: http://www.thefreelibrary.com/After+First+45+Days,+Priceline.com's+New+Car+Sales+Pass+$2+Million...-a053018510. They can also name the counties to which they are willing to travel to take delivery of a new car. Priceline.com then faxes the offer to all factory authorized dealers in the specified counties after removing the name to protect the buyer's privacy. The sale goes to the first dealership which has the exact car and is willing to sell at the buyer's price. It is understood that priceline.com intends to add financing options to enable consumers to name their own monthly payment plan for their new cars. Priceline has obtained U.S. Pat. No. 5,794,207 for its e-commerce system. This patent is incorporated herein in its entirety.

While the above examples of known online sites for buying or leasing a vehicle offer varying degrees of improvement over the time-honored method of visiting the dealer showroom with its attendant disadvantages for the buyer, they still include varying degrees of inefficiency and difficulties for the buyer or leasor of a vehicle. Additionally, none of these programs allow a consumer to interact with a dealership, or a plurality of dealerships, in a way that removes the inherent bias associated with in-person leasing or buying of a vehicle.

The present invention provides a solution to help resolve these problems and inefficiencies experienced by consumers during the buying or leasing process.

The present invention solves the aforementioned problems by providing a modernized arena to facilitate transactions, where today's vehicle consumers can set the price they want to pay and bypass the outdated negotiations necessary when doing business at a dealership. In addition, the consumers can also shop for car insurance and financing.

In addition, the present invention allows today's vehicle consumer to circumvent the old haggling way of negotiating a vehicle price whether for purchase or lease. It is well known that the price you pay for a vehicle depends on how much you are willing to negotiate. The present invention modernizes the vehicle and insurance buying, or leasing, experience, putting more power into the consumer's hand. It also allows the buyer to make multiple offers to dealers at the same time, letting the market dictate price. Additionally, dealerships will be able to interact with the consumer in a more uniform way without biasing information such as name, age, gender, ethnicity, language spoken, address, and job description.

As such, the present invention changes and transforms the car buying and leasing process—transforming the process into a new and different process that is more effective, efficient, fair and balanced for both the consumers and the dealerships.

Some additional advantages of the present invention are cost savings to the consumer, transaction time saved by both consumer and dealer, and a higher likelihood of consumer getting exactly what the consumer is looking for.

### BRIEF SUMMARY OF THE INVENTION

The present invention is directed to a computer implemented web based method for leasing or purchasing a vehicle, comprising providing at least one web based database server including a processor and a computer readable memory storage medium coupled to the processor, wherein the computer readable memory storage medium contains program instructions implementing the steps herein; creating at least one electronic database in the web based database server; populating the electronic database with information data of a plurality of vehicles and preexisting leasing or purchasing information; providing access to the electronic database via a computer implemented internet-network to at least one of a plurality of customers so the customer can lease or purchase a vehicle by: searching in the at least one electronic database for a vehicle to be leased or purchased; selecting and building the vehicle to be leased or purchased; retrieving a predetermined plurality of preexisting leasing or purchasing information for review by the customer; creating a leasing or purchase offer for the selected and built vehicle; submitting an offer to a predetermined plurality of dealers so as to permit the dealers to evaluate the offer via the computer implemented internet-network; and receiving the first acceptance by one of the dealers of the submitted leasing or purchase offer.

The computer implemented web based method further comprises providing for the at least one customer to logon to the web based electronic database via the computer network. Populating the electronic database comprises collecting preexisting leasing or purchasing information of leased vehicles for purchase from each of the dealers and storing the preexisting leasing or purchasing info′ nation for leased vehicles in the information data in the web based electronic database.

In one exemplary embodiment, the preexisting leasing or purchasing information of leased or for-purchase vehicles comprises past leasing or purchase offers of other customers. In another exemplary embodiment, the leasing or purchasing information of leased or for-purchase vehicles comprises preexisting leases or purchases of other customers. In another exemplary embodiment, searching for a vehicle comprises selecting a style, a price, and a manufacturer for the vehicle to be leased or purchased. After selecting a vehicle a user can “build” the vehicle to be leased or purchased. Building the vehicle, as understood in this invention, is selecting customizing options that are desired in the selected vehicle. Building the vehicle can include selecting a color, options and accessories for the vehicle to be leased or purchased. The computer implemented web based method can further comprise inputting information by the customer so as to permit a credit check. In an exemplary embodiment, the customer's offer is accepted and a down payment and fee is charged prior to submitting the customer's offer to the dealers.

In addition, the present invention is directed as well to a computer implemented web based system for leasing or purchasing a vehicle. The system comprises at least one web based database server including a processor and a computer readable memory storage medium coupled to the processor; at least one electronic database created in the web based database server; the electronic database being populated with information data of a plurality of vehicles and preexisting leasing or purchase information; a computer implemented internet-network configured for use by at least one of a plurality of customers seeking to lease or purchase a vehicle, wherein the computer readable memory storage medium contains program instructions so that the customer can search in the at least one electronic database for a vehicle to be leased; select and build the vehicle to be leased or purchased; retrieve a predetermined plurality of preexisting leasing information for review by the customer; create a leasing or purchase offer for the selected and built vehicle; submit an offer to a predetermined plurality of dealers so as to permit the dealers to evaluate the offer via the computer implemented internet-network; and receive the first acceptance by one of the dealers of the submitted leasing or purchase offer.

In an exemplary embodiment, the computer implemented internet-network is configured with a graphical user interface so that the at least one customer can logon to said web based electronic database via said computer network. In another exemplary embodiment, the electronic database is populated with preexisting leasing or purchase information of leased vehicles or vehicles to be purchased which is collected from each of said dealers, and wherein the preexisting leasing or purchasing information for leased or purchased vehicles is stored in the information data in the web based electronic database, the computer implemented internet-network being configured with a graphical user interface so that the customer can selectively view the preexisting leasing or purchase information for leased of for-purchase vehicles which is stored in the information data in the web based electronic database.

The preexisting leasing information of leased vehicles can comprise past leasing offers of other customers. It can also comprise preexisting leases of other customers. In another exemplary embodiment, the computer implemented internet-network is configured with a graphical user interface so that the customer can search for a vehicle by selecting a style, a price, and a manufacturer for the vehicle to be leased or purchased.

The computer implemented internet-network can also be configured with a graphical user interface so that the customer can select and build the vehicle to be leased or purchased by selecting a color, options and accessories for the vehicle to be leased or purchased. In yet another exemplary embodiment, the computer implemented internet-network is configured with a graphical user interface so that the customer can input information so as to permit a credit check. In addition, the computer implemented internet-network is configured with a graphical user interface so that when the customer's offer is accepted by the dealer, a down payment and fee is charged.

Moreover, this invention is also concerned with a computer readable memory storage medium comprising computer readable instructions that, when executed by a computer processor, provide a graphical user interface for accessing a web based electronic database for leasing a vehicle, and for implementing the steps of method of the present invention.

In an exemplary embodiment, the computer readable memory storage medium further comprises computer readable instructions that, when executed by a computer processor, provide a graphical user interface so that said at least one customer can logon to the web based electronic database via the computer network. Another exemplary embodiment includes a computer readable memory storage medium that further comprises computer readable instructions that, when executed by a computer processor, provide a graphical user interface so that the customer can selectively view the preexisting leasing information for leased vehicles which is stored in the information data in the web based electronic database.

### BRIEF DESCRIPTION OF THE DRAWINGS

The present invention is described below with reference to the drawings in which:

FIG. 1 is a diagrammatic flow chart of a computer network implemented embodiment of a virtual online vehicle marketplace of the present invention for leasing or purchasing a vehicle which includes logging on, searching for a vehicle, and selecting and building a vehicle to be leased or purchased.

FIG. 2 is a diagrammatic flow chart of a computer network implemented embodiment of a virtual online vehicle marketplace of the present invention for leasing or purchasing a vehicle which includes inputting information of the customer, retrieving past offers and/or leases, reviewing past offers and/or leases, and creating an offer for the vehicle selected and built by the customer.

FIG. 3 is a diagrammatic flow chart of a computer network implemented embodiment of a virtual online vehicle marketplace of the present invention for leasing or purchasing a vehicle which includes submitting an offer, distributing the offer to dealers, acceptance or a counteroffer by the dealer, notifying the customer of the acceptance or counteroffer, and charging the customer the down payment and fees.

FIG. 4 is a graphic illustration of an exemplary computer network implemented embodiment of a virtual online vehicle marketplace of the present invention for leasing a vehicle.

### DETAILED DESCRIPTION OF THE PREFERRED EMBODIMENTS

In the description which follows, any reference to direction or orientation is intended primarily and solely for purposes of illustration and is not intended in any way as a limitation to the scope of the present inventions. Also, the particular embodiments described herein, although being exemplary, are not to be considered as limiting of the present inventions.

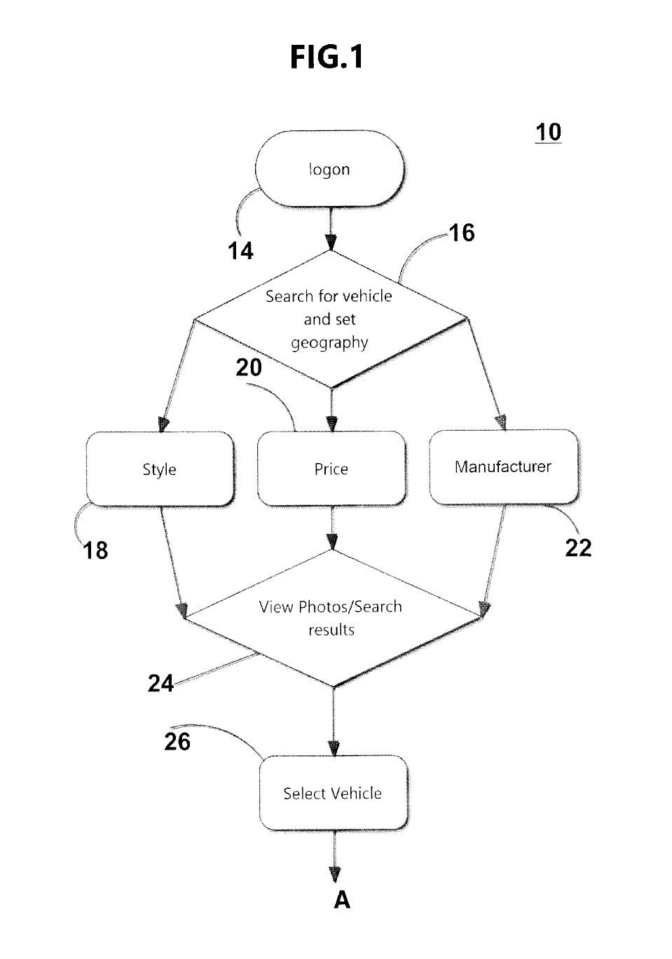

In FIG. 1, a diagrammatic flow chart is shown of a computer web based network implemented embodiment of a virtual online vehicle marketplace 10 of the present invention for leasing a vehicle. While this exemplary embodiment is concerned with a vehicle leasing marketplace, the present invention is also applicable to a vehicle purchasing marketplace as well as a virtual marketplace for other products as well.

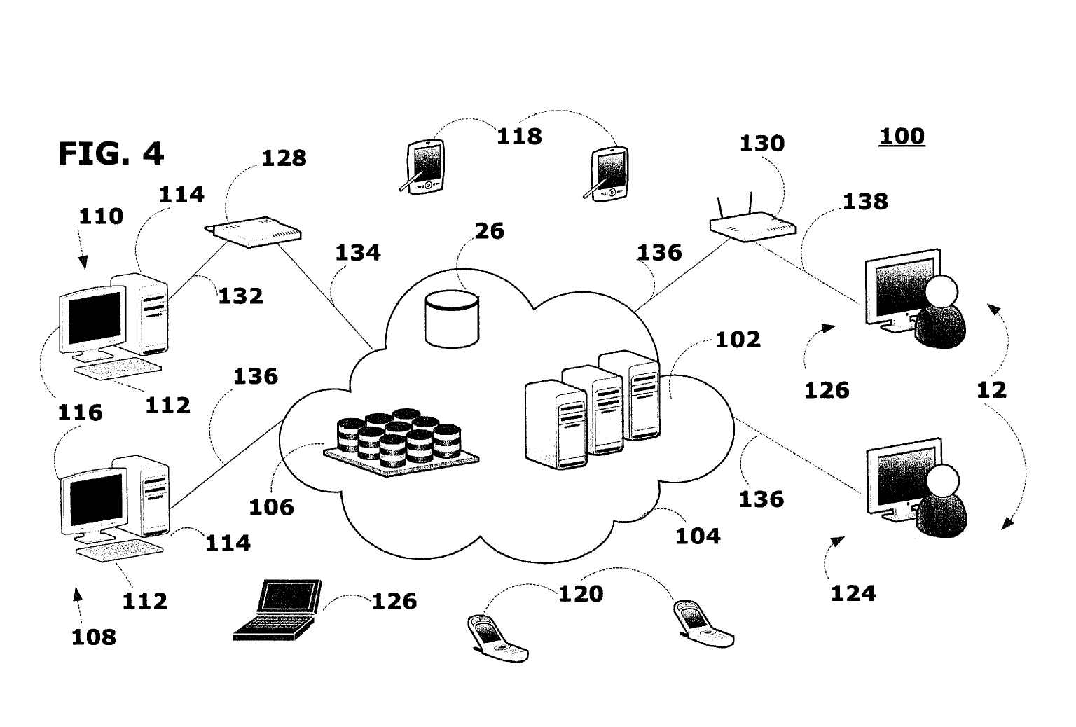

The consumer or customer, as shown for example at 12 in FIG. 4, can logon 14 to a predetermined website such as, for example, DealerPinch.com which is being developed to implement the method of the present invention. In this fashion, the consumer 12 will have the opportunity to search 16 for a new or used vehicle to lease or purchase. In the exemplary embodiment of FIG. 1, the consumer 12 can search for a vehicle according to one of three criteria. Namely the consumer 12 can search by style 18 or model of vehicle, price range 20 and directly by manufacturer 22. In addition, the consumer 12 can set the geographical parameters of the search (for example, 50 miles away, 100 miles away, etc.). This will enable the consumer 12 to decide how far the dealer can be from the consumer's present or home location.

If the consumer 12 searches by style 18 of vehicle, for example Sedan, they will be shown photos 24 in a scrolling manner of each manufacturer's offerings in this style. A consumer 12 will then choose a particular manufacturer's model to continue with.

Should the consumer 12 search by price range 20, for instance $151-200 monthly payment, based off of true drive offs, they will be shown offerings from each manufacturer that are based off of historical and trending data that would be collected and that would be available in this price range. The historical and trending data that would be collected can be populated in a database 26 as shown in FIG. 4.

In a third search option, the consumer 12 can search by manufacturer 22. By using this option, the consumer 12 can directly choose the model and style that they would like.

Although in the exemplary embodiment illustrated in FIG. 1, the consumer 12 can choose one of three search options, it is contemplated that the consumer 12 can also choose any combination of these options. For example, the consumer 12 could search by style 18 and price 20, by style 18 and manufacturer 22, or other possible combinations including all three search options, if desired. Also, there could be additional search options if desired in addition to the three specified in the present exemplary embodiment.

Once a consumer 12 has narrowed down the search 16 and selected 26 a particular manufacturer 22 and style 18 or model, they can begin to build 28 the specific choice of vehicle. The build process 28 includes being shown and choosing the various color 30, interior options 32 as well as available accessories 34 for the vehicle. They are instructed to choose the minimum accessories 34 and color 30 options that they will accept (“must haves,” or required features, for a deal to be facilitated). If the vehicle contracted or selected has additional features, it is an added bonus.

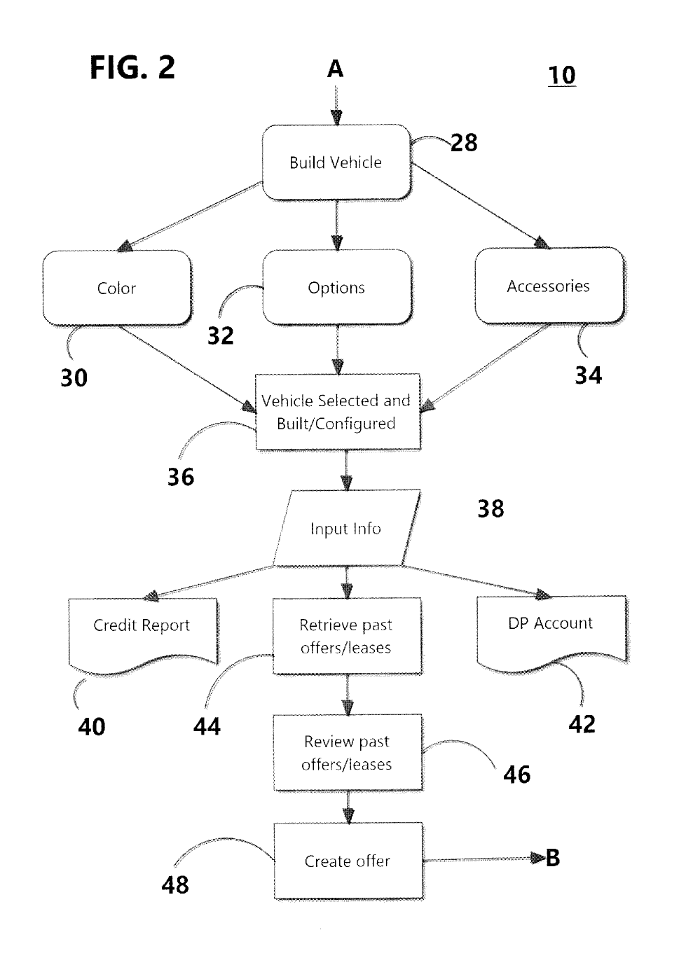

Once the desired vehicle has been selected and built and thus configured 36, the consumer 12 fills out a brief questionnaire with input information 38, as shown in FIG. 2, which will include necessary minimum information to render a credit report 40 which will be provided to the dealerships along with the offer 48. The consumer 12 will also create their DealerPinch account 42 complete with billing and credit card information. It should be noted that this procedure helps provide the consumer 12 with a more user friendly website experience since the consumer 12 can shop for a desired vehicle without having first to register by providing personal information as is sometimes required in other online website procedures while shopping for products. If the consumer 12 does not find what they want, they can simply drop out of the process of the present invention without having had to provide personal information in what may have been an unsuccessful attempt to locate a new or used vehicle to lease or purchase.

After the account 42 is set up, they will be entitled to retrieve a number of preexisting offers/leases or past leasing offers 44. Upon doing so, the consumer 12 can at their leisure review 46 recently accepted offers 44 and/or preexisting leases 44 for vehicles similar to their own. In this manner, they will be able to create an offer 48 including term, miles per year, down payment and monthly payment, or, straight purchase price, if desired. By viewing such past offers and/or preexisting leases 44, the consumer will be better informed and feel more comfortable in deciding what offer to make. Again all of this process is done without the pressure and stress that could be present had the consumer directly visited a leasing dealership.

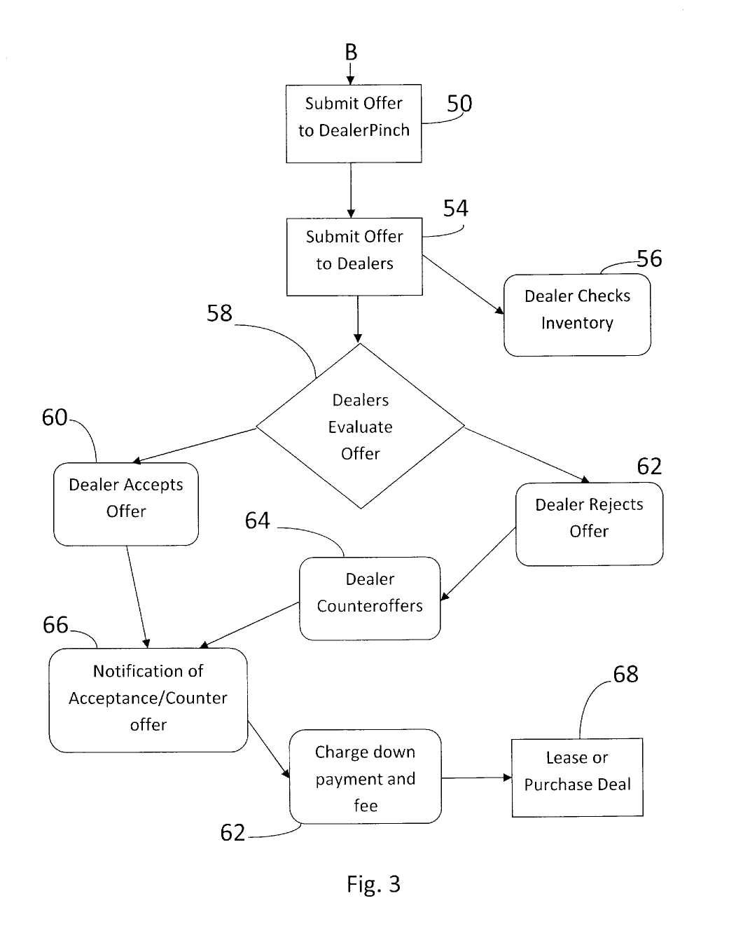

Such preexisting offers/leases or past leasing offers 44 can be obtained by the dealers who would also have access to the offers created 48 by the consumer 12. As an incentive to encourage dealers to submit or contribute such preexisting offers/leases or past leasing offers 44, the dealers will be allowed to access the web based internet network either at no cost or at a reduced cost or subscription fee in accordance with a sliding scale depending on the number of preexisting leases and/or past leasing offers 44 provided by the dealers. The leasing information data such as either preexisting offers/leases or past leasing offers 44 can then be used to populate the electronic database 26. In addition, the database 26 can be populated with vehicle information that can be accessed by the consumer 12 during the search 16 and configuration 36 steps of the method of FIGS. 1-3. The leasing information data can be populated into the database 26 in various formats. In one exemplary embodiment, entire preexisting leases or purchase offers with personal information being redacted can be obtained in .PDF or various image document formats and stored in the database 26. In an alternative exemplary embodiment, any of the well known parsing programs can be used to extract various information data records and to store such records in a relational database in database 26. Such extraction can also be down with past leasing offers.

The consumer 12 is informed that if they make or create an offer 48, it becomes a binding agreement upon acceptance. Offers 48 are then also submitted 54 to partner dealers within the selected geographical range. Dealers then utilize either internal systems or DealerPinch inventory system to determine or check their inventory 56 that matches the minimum requirements of the vehicle configured 36 by the consumer 12. The dealers also review and evaluate 58 the consumer's offer 48 as well as a copy of the consumer's credit report 40 without biasing customer information. The dealers can compare the offer 48 to their in house inventory and are prompted to either accept 60 the consumer's offer or reject 62 the offer 48. The first dealer to accept the offer 48 locks out and prevents the other dealers from further action. The first dealer to accept the offer 48 may execute the contract. Once a dealer accepts the offer 60, the consumer 12 receives notification 66 of the dealer's acceptance 60. Such notification 66 can be implemented by an email saying congratulations, your offer has been accepted. If the dealer rejects the offer 62, the dealer can attempt to counteroffer 64, which will process unless the offer has been accepted 60 by another dealer. In the case of a counteroffer 64, the customer 12 receives notification 66 of the counteroffer. If no dealer accepts the consumer's offer 48, then the consumer 12 receives any and all counter offers 64 and can choose to accept or decline. If the customer 12 accepts the counter offer, then the lease has been agreed to.

Thereafter, the contract is executed and the consumer 12 shall arrange for pickup or delivery of their vehicle. They can arrive at the dealership and sign the lease, finance or purchase documents and a down payment and fee can be charged 62 because a lease deal 68 has been achieved.

In an alternative exemplary embodiment, the computer implemented web based virtual marketplace of the present invention will also apply to vehicle insurance companies in addition to vehicle dealerships.

In FIG. 4, a computer implemented web based system 100 of the present invention is shown with various components that can be utilized for performing the method as illustrated in FIGS. 1-3.

The system 100 can be implemented using general purpose computer hardware as a network site. The general purpose hardware may advantageously be in the form of a workstation or other suitable computer. The hardware will be configured and customized by various software modules. The software modules will include communications software of the type conventionally used for Internet communications and a database management system. Any number of commercially available database management systems may be utilized to implement the present invention. Those of ordinary skill in the art of database management application programming will be able to make and use the invention according to the disclosure hereof.

The system 100 will also include an iterative search engine which handles queries to the database 26. The operational features of the iterative search engine may be implemented through commercially available database management systems. Other conventional search and query capabilities may also be used to search the database 26. While the database 26 can contain text information, the leasing information data can also include other data types such as sound clips, pictures, and videos.

As shown in FIG. 4, various computers can be used by the customer 12 to access the web based database servers 102 through the internet 104. The database servers 102 are coupled to the electronic database 26 which can be established in a hardware component separate from the database server 102.

In an alternative exemplary embodiment, the electronic database 26 can be situated within the database server 102. The web based database server 102 includes a processor (not shown) and a computer readable memory storage medium coupled to the processor. Although the database server 102 in FIG. 4 is shown as three components, the database server 102 can be formed in one component or multiple components. In yet another alternative embodiment, additional computer readable memory storage medium 106 can be provided and is coupled to the database server 102 and the electronic database 26 for additional memory storage capability. In this manner, the electronic database 26 can be populated with information data concerning at least vehicles and preexisting leasing information.

The computers shown in FIG. 4 include workstations 108 and 110. Each contains a keyboard 112, a desktop tower 114 and a display 116. A mouse (not shown) can also be provided. The desktop tower 114 contains a processor (not shown), computer readable memory storage medium and other components that typically accompany a workstation computer that can be coupled to the internet 104 or work in a standalone operational mode when not coupled to the internet 104.

In an alternative exemplary embodiment, the displays 116 can be touch screens in which instance, customer 12 commands can be entered by touching various input controls on the graphic user interfaces (GUI) displayed on the touch screen. For example, the customer 12 can logon to the DealerPinch website by touching a logon command displayed in the GUI on the touch screen. Similarly, all of the steps of the method of the present invention can be implemented by the customer 12 by interactively touching various command buttons and accessing various menus that can be displayed on the GUIs presented in the various displays of the computers in FIG. 4.

Alternatively, the computers in FIG. 4 include PDA's or tablets 118, cell phones or smart phones 120 or thin client computer stations 122 and 124 and a laptop 126. Any of the computers of FIG. 4 can be coupled to the internet 104 through a direct wire router 128 or a wireless router 130. By way of example, the workstation 110 is shown coupled though wire or fiber optic cable connection 132 to router 128 which is coupled to the internet 104 though wire or fiber optic cable connection 132. Alternatively, workstation 108 is shown coupled directly through connection 136 which can be any of a direct wire or fiber optic cable connection, WIFI, LAN, WAN, Bluetooth or other coupling which is available in the internet market. Thin client computer 124 is also shown as being coupled to the internet by any of the available internet connections 136. Generally the PDA's or tablets 118 and the cell phones or smart phones 120 can be coupled to the internet through mobile connections (not shown). The laptop 126 can also be coupled to the internet either through a connection 136. Any of the various computers in FIG. 4 can also be coupled to the internet 104, as is thin client 122, via a wireless connection 138 to the wireless router 130 that itself is coupled to the internet 104.

After a customer 12 establishes access to the system 100 through one of the available computers connected to the internet, they can be presented with a variety of menus via a graphical user interface (GUI) on the various displays shown throughout the computers in FIG. 4.

In this manner, a customer 12 through the computer network web based implemented system 100 is provided access to the web based electronic database 26 that is remotely located from the customer 12. The web based electronic database 26 is populated with information that is at least collected from various dealers and manufacturers. The customer 12 interacts with the database 26 through a series of queries.

The following is a glossary of terms used or applicable in this application with respect to the various embodiments of the present invention.

Storage Memory—Any of various types of memory devices or storage devices that are computer readable. The computer readable storage medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The term “storage memory” is also intended to include an installation medium, e.g., a CD, DVD, floppy disks, or tape device, a computer system memory or random access memory such as DRAM, DDR RAM, SRAM, EOO RAM, Rambus RAM, etc.; or a non-volatile memory such as a magnetic media, e.g., a hard drive, or optical storage. The storage memory may comprise other types of memory as well, such as flash memory, or combinations thereof. Other examples of storage medium include thumb drives and memory sticks. In addition, the storage memory may be located in a first computer in which the programs are executed, or may be located in a second different computer which connects to the first computer over a network, such as an Intranet or Internet. In the latter instance, the second computer may provide program instructions to the first computer for execution. The term “storage memory” may include two or more memory mediums which may reside in different locations, e.g., in different computers or other electronic devices such as for example, without limitation, cellphones, smartphones, iphones, tablets or pads that are connected over a network.

Program—The term “program” is intended to have the full breadth of its ordinary meaning. The term “program” includes a software program which may be stored in a memory and is executable by a processor or a hardware configuration program useable for configuring a programmable hardware element.

Software Program—The tem′ “software program” is intended to have the full breadth of its ordinary meaning, and includes any type of program instructions, code, script and/or data, or combinations thereof, that may be stored in a computer readable storage memory or a programmable hardware element and which program instructions, code, script and/or data, or combinations thereof, can be executed by a processor or microprocessor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate with one another.

Graphical User Interface—This term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program. Alternatively, the user can place terminal nodes which may cause the display of corresponding GUI elements front panel objects in the GUI, either at edit time or later at run time.

Front Panel—A Graphical User Interface that includes input controls and output indicators, and which enables a user to interactively control or manipulate the input being provided to a program, and view output of the program, while the program is executing. A front panel is a type of GUI.

Graphical User Interface Element—An element of a graphical user interface, such as for providing input or displaying output. Exemplary graphical user interface elements comprise input controls and output indicators.

Input Control—A graphical user interface element for providing user input to a program. Exemplary input controls comprise sliders, input text boxes, etc.

Output Indicator—A graphical user interface element for displaying output from a program. Exemplary output indicators include charts, graphs, output text boxes, etc. An output indicator is sometimes referred to as an “output control”.

Computer System—Any of various types of computing or data processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) or components and including without limitation, cellphones, smartphones, tablets or pads, and which have at least one processor that executes instructions from a storage memory. The data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) can be coupled to the computer system either directly or through intervening I/O controllers. Network adapters may also be coupled to the computer system to enable the data processing system to become coupled to other data processing systems or remote printers or storage devices through intervening private or public networks. Modems, cable modem and Ethernet cards are just a few of the currently available types of network adapters.

The embodiments herein may comprise hardware and software embodiments. This invention can be implemented in either in hardware or software. The embodiments that are implemented in software include, but are not limited to, firmware, resident software, microcode, etc. Furthermore, the embodiments herein can take the form of a computer program product accessible from a computer-usable or computer-readable storage medium providing program code for use by or in connection with a computer or any instruction execution system. For the purposes of this description, a computer-usable or computer readable storage medium can be any apparatus that can comprise, store, communicate, propagate, or transport the program for use by or in connection with the instruction execution system, apparatus, or device.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The teen module may include memory (shared, dedicated, or group) that stores code executed by the processor. The term code, as used above, may include software, firmware, and/or microcode, and may refer to programs, routines, functions, classes, and/or objects. The term shared, as used above, means that some or all code from multiple modules may be executed using a single (shared) processor. In addition, 10 some or all code from multiple modules may be stored by a single (shared) memory. The term group, as used above, means that some or all code from a single module may be executed using a group of processors. In addition, some or all code from a single module may be stored using a group of memories.

Thick clients, also called heavy clients, are full-featured computers that are connected to a network. Unlike thin clients, which lack hard drives and other features, thick clients are functional whether they are connected to a network or not.

Database Server—An independently functioning computer in a local-area network that holds and manages the database. The database server is a computer that provides data to other computers. It may serve data to other computers on a local area network (LAN) or a wide area network (WAN) over the Internet. Database servers are dedicated computers that hold the actual databases and run only the DBMS and related software. Database servers are usually multiprocessor computers, with generous memory and RAID disk arrays used for stable storage. RAID is used for recovery of data if any of the disks fail.

The term database server may refer to both hardware and software used to run a database, according to the context. It may also refer to the physical computer used to host the database. If in this context, the database server is typically a dedicated higher-end computer that hosts the database.

A database server is a computer in a local area network (LAN) that is dedicated to database storage and retrieval. The database server holds the Database Management System (DBMS) and the database(s) itself. Upon requests from the customer 12, the DBMS searches the database for selected information data and passes it back over the network.

In a typical database network, the customer 12 can execute structured query language (SQL) requests to the database server. The customer database request and the answers of the SQL command are returned over the network to the computer used by the customer 12.

The system 100 and method 10 described herein may be implemented by one or more computer programs executed by one or more processors. The computer programs include processor-executable instructions that are stored on a non transitory tangible computer readable storage medium. The computer programs may also include stored data. Non-limiting examples of the non-transitory tangible computer readable storage medium include, for example, nonvolatile memory, magnetic storage, and optical storage.

Referring to FIG. 4, each of the computers such as workstations or desktops, thin clients, PDA's, tablets, cellphones, smartphones or touch screen computers have storage. Hence each of these computers is capable of storing programs for operation of the method of the present invention. In addition, each of these computers can have a programmable hardware element which can also store operational programs or portions thereof. For example, storage memory is also disposed within the desktop which can be replaced with a laptop or other computing component which has a processor. Access to the operational programs is provided by use of a physical or virtual keyboard and/or mouse and the LCD or other display to show the operational status of the method 10.

In one exemplary embodiment, a GUI is provided on the LCD to allow for graphical and/or touch screen operation on the display. If desired, the display can indicate the various operational states of the method of the present invention. In one example, the display can illustrate which steps are being processed or implemented during operation of the method 10 of the present invention. The display can also illustrate the results of notifications 66 whether the dealers accepted or rejected the created offer 48 by the consumer 12. The display can also show any counteroffers 64 by the dealers.

Operational programs or portions thereof containing computer readable instructions for implementing the method 10 of the present invention can be stored, according to alternative preferred embodiments, in the database server 102, in the storage memory in any of the available computers, and also in storage memory in the database 26 or in additional computer readable memory storage medium 106.

While the present invention has been shown and described herein in what are conceived to be the most practical and preferred embodiments, it is recognized that departures, modifications, adaptations, variations and alterations in the described methods and systems may be made and will be apparent to those skilled in the art of the foregoing description which does not depart from the spirit and scope of the invention which is therefore not to be limited to the details herein.

For this reason, such changes are desired to be included within the scope of the appended claims. The descriptive manner which is employed for setting forth the embodiments should be interpreted as illustrative but not limitative of the full scope of the claims which embrace any and all equivalents thereto.

It is to be further understood that other features and modifications to the foregoing detailed description are within the contemplation of the present invention, which is not limited by this detailed description. Those skilled in the art will readily appreciate that any number of configurations of the present invention and numerous modifications and combinations of materials, components, arrangements and dimensions can achieve the results described herein, without departing from the spirit and scope of this invention. Accordingly, the present invention should not be limited by the foregoing description, but only by the appended claims.

What is claimed is:

1. A computer implemented web based method for leasing or purchasing a vehicle, comprising:
providing at least one web based database server including a processor and a computer readable memory storage medium coupled to the processor, wherein the computer readable memory storage medium contains program instructions implementing the steps herein;
creating at least one electronic database in said web based database server;
populating said electronic database with information data of a plurality of vehicles and preexisting leasing or purchase information;
providing access to said electronic database via a computer implemented internet-network to at least one of a plurality of customers so said customer can lease or purchase a vehicle by:
searching in said at least one electronic database for a vehicle to be leased or purchased;
selecting and building a vehicle to be leased or purchased;
reviewing a predetermined plurality of said preexisting leasing or purchase information retrieved from said electronic database based on said search and selection of necessary features;
creating a leasing or purchase offer for the selected and built vehicle;
creating a credit report based on inputting minimum necessary information;
submitting said offer and said credit report to at least one of a plurality of dealers so as to permit the dealers to evaluate the offer via said computer implemented internet-network; and
receiving an acceptance of said offer by at least one of said plurality of dealers.

2. The computer implemented web based method of claim 1 further comprising providing for said at least one customer to logon to said web based electronic database via said computer network.

3. The computer implemented web based method of claim 1 further wherein populating said electronic database comprises collecting preexisting leasing or purchase information of vehicles from each of said plurality of dealers and storing said preexisting leasing or purchase information for leased or purchase vehicles in said information data in said web based electronic database.

4. The computer implemented web based method of claim 3 wherein said preexisting leasing or purchase information of leased or purchase vehicles comprises past leasing or purchase offers of other customers.

5. The computer implemented web based method of claim 3 wherein said preexisting leasing or purchase information of leased or purchase vehicles comprises preexisting leases or purchases of other customers.

6. The computer implemented web based method of claim 1 wherein searching for a vehicle comprises selecting a style, a price, and a manufacturer for the vehicle to be leased or purchased.

7. The computer implemented web based method of claim 1 wherein selecting and building the vehicle to be leased or purchased comprises selecting a color, options and accessories for the vehicle to be leased or purchased.

8. The computer implemented web based method of claim 1 wherein said customer's offer is accepted and a down payment and fee is charged prior to submitting the customer's offer to the dealers.

9. The computer implemented web based method of claim 1 wherein said credit report does not include biasing information about said at least one customer, said biasing information comprising information about said at least one customer's gender, age, name, ethnicity, address, job description, and primary language spoken.

10. A computer implemented web based system for leasing or purchasing a vehicle, comprising:
at least one web based database server including a processor and a computer readable memory storage medium coupled to the processor;
at least one electronic database created in said web based database server;
said electronic database being populated with information data of a plurality of vehicles and preexisting leasing or purchase information;
a computer implemented internet-network configured with a graphical user interface so that said at least one customer can logon to said web based electronic database via said computer network, said computer implemented internet-network configured for use by at least one of a plurality of customers seeking to lease or purchase a vehicle, wherein the computer readable memory storage medium contains program instructions so that said customer can:
search in said at least one electronic database for a vehicle to be leased or purchased;
select and build the vehicle to be leased or purchased;
review a predetermined plurality of preexisting leasing or purchase information retrieved from said at least one electronic database;
create a leasing or purchase offer for the selected and built vehicle;
create a credit report based on inputting minimum necessary information;
submit said offer and said credit report to a predetermined plurality of dealers so as to permit the dealers to evaluate the offer via said computer implemented internet-network; and
receive the first acceptance by one of the dealers of the submitted leasing or purchase offer.

11. The computer implemented web based system of claim 10 wherein said electronic database is populated with preexisting leasing or purchase infatuation of leased or purchase vehicles which is collected from each of said dealers, and wherein said preexisting leasing or purchase information for leased or purchase vehicles is stored in said information data in said web based electronic database, said computer implemented internet-network being configured with a graphical user interface so that said customer can selectively view said preexisting leasing or purchase information for leased or purchase vehicles which is stored in said information data in said web based electronic database.

12. The computer implemented web based system of claim 11 wherein said preexisting leasing information of leased vehicles comprises past leasing offers of other customers.

13. The computer implemented web based system of claim 11 wherein said preexisting leasing information of leased vehicles comprises preexisting leases of other customers.

14. The computer implemented web based system of claim 10 wherein said computer implemented internet-network is configured with a graphical user interface so that said customer can search for a vehicle by selecting a style, a price, and a manufacturer for the vehicle to be leased.

15. The computer implemented web based system of claim 10 wherein said computer implemented internet-network is configured with a graphical user interface so that said customer can select and build the vehicle to be leased by selecting a color, options and accessories for the vehicle to be leased.

16. The computer implemented web based system of claim 10 wherein said computer implemented internet-network is configured with a graphical user interface so that said customer can input minimum information so as to permit a credit check.

17. The computer implemented web based system of claim 10 wherein said computer implemented Internet-network is configured with a graphical user interface so that said customer's offer is accepted and a down payment and fee is charged prior to submitting the customer's offer to the dealers.

18. A computer readable memory storage medium comprising computer readable instructions that, when executed by a computer processor, provide a graphical user interface for accessing a web based electronic database for leasing a vehicle, and for implementing the steps of:
providing at least one web based database server including a processor and a computer readable memory storage medium coupled to the processor, wherein the computer readable memory storage medium contains program instructions implementing the steps herein;
creating at least one electronic database in said web based database server;
populating said electronic database with information data of a plurality of vehicles and preexisting leasing or purchase information;
providing access to said electronic database via a computer implemented internet-network to at least one of a plurality of customers so said customer can lease or purchase a vehicle by:
searching in said at least one electronic database for a vehicle to be leased or purchased;
selecting and building a vehicle to be leased or purchased;
reviewing a predetermined plurality of said preexisting leasing or purchase information retrieved from said electronic database based on said search and selection of necessary features;
creating a leasing or purchase offer for the selected and built vehicle;
inputting minimum information necessary to render a credit report;
submitting said offer and said credit report to at least one of a plurality of dealers so as to permit the dealers to evaluate the offer via said computer implemented internet-network; and
receiving an acceptance of said offer by at least one of said plurality of dealers.

19. The computer readable memory storage medium of claim 18 further comprising computer readable instructions that, when executed by a computer processor, provide a graphical user interface so that said at least one customer can logon to said web based electronic database via said computer network.

20. The computer readable memory storage medium of claim 18 further comprising computer readable instructions that, when executed by a computer processor, provide a graphical user interface so that said customer can selectively view said preexisting leasing information for leased vehicles which is stored in said information data in said web based electronic database.
